(19) United States
(12) Patent Application Publication
(10) Pub. No.: US 2007/0275679 A1
(43) Pub. Date: Nov. 29, 2007

(54) Radio receiver for aviation communications and navigation

(76) Inventors: Timothy P. Gibson, Overland Park, KS (US); Gregory L. Triplett, Olathe, KS (US); Manuel F. Richey, Paola, KS (US); Jeffrey K. Hunter, Olathe, KS (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/563,397

(22) PCT Filed: Jul. 9, 2004
(86) PCT No.: PCT/US04/21885

§ 371 Date: Jan. 5, 2006

Related U.S. Application Data
(63) Continuation-in-part of application No. 10/616,796, filed on Jul. 10, 2003.

(51) Int. Cl. H04B 1/40

(52) U.S. Cl. 455/179.1

(57) ABSTRACT

A radio receiver is provided that includes a front-end circuit operable to receive radio signals transmitted across a frequency band and generate an analog signal corresponding to a plurality of channels within the frequency band. Also included is an analog to digital converter operable to convert the analog signal to a digital signal, and a digital processing system operable to process the digital signal and simultaneously generate one or more output signals corresponding to at least one of the plurality of channels within the frequency band. Various exemplary embodiments of the radio receiver and associated method are provided.

### BACKGROUND OF THE INVENTION

1. Field of the Invention

The present invention relates to radio receivers, and more particularly to broadband radio receivers used for aviation communications and navigation.

2. Description of Related Art

Aviation communications and navigation relies heavily on radio signal broadcasts to provide critical information to those involved in piloting and controlling aircraft. Pilots use various types of radio receivers and instruments carried on an aircraft to communicate with ground controllers, air traffic controllers, and pilots of other aircraft, as well as to receive all of the radio signal broadcasts required to safely operate the aircraft. For example, some radio receivers may be used to receive broadcast navigation signals to determine aircraft position and course. Other radio receivers may be used to receive broadcast glide slope signals to assist in landing the aircraft. Still other radio receivers may be used to monitor broadcasts providing weather and runway condition information.

Because the radio signal broadcasts are transmitted over various frequency ranges using various modulation and encoding schemes, a separate radio receiver for each individual channel of a given type of broadcast is typically carried in the cockpit of an aircraft. For example, an aircraft may carry a very-high frequency (VHF) communications receiver tuned to receive only one communications channel at a time, an automatic direction finder (ADF) receiver tuned to receive only one navigation channel at a time, a VHF data link (VDL) receiver tuned to receive data from only one channel at a time, a glide slope receiver tuned to receive only one glide scope channel at a time, as well as various other communications receivers. Each of these radio receivers processes only one channel at a time and, if the data is digitized using an analog to digital converter, only one channel of information is digitized using that converter. As a result, multiple radio receivers (or multiple analog RF front ends in a single radio receiver) are needed to receive more than one channel at a time.

There are a number of disadvantages associated with carrying multiple radio receivers (each of which is limited to one channel of information) in the cockpit of an aircraft. For example, the radio receivers needed to pilot an aircraft (each of which is often housed within a separate enclosure or case) occupy valuable airframe space. Also, the sheer number of radio receivers adds weight to the aircraft. In addition, the radio receivers together consume a large amount of electrical power from the aircraft. Other disadvantages should be apparent to those skilled in the art.

### SUMMARY OF THE INVENTION

The present invention is directed to a radio receiver that is operable to receive one or more radio frequency bands containing a plurality of information channels using various modulation and encoding schemes, digitize the plurality of received channels using a single analog to digital converter, digitally select and decode one or more of the plurality of digitized channels, and generate one or more output signals that correspond to one or more of the plurality of digitized channels. The radio receiver may be used to replace multiple conventional aviation radio receivers to thereby free up airframe space and reduce weight and power consumption, while still allowing a flight crew to receive all of the radio signal broadcasts required to safely operate an aircraft.

In a first exemplary embodiment, the radio receiver includes a single front-end circuit operable to receive a plurality of radio signals transmitted across a frequency band and generate an analog signal corresponding to a plurality of channels within the frequency band. Preferably, the front-end circuit includes an antenna circuit operable to receive the radio signals, an amplifier circuit operable to amplify the received radio signals, a filter circuit operable to filter the received radio signals, and/or an intermediate frequency mixing circuit operable to translate the received radio signals to an intermediate frequency band. The radio receiver also includes a single analog to digital converter operable to receive the analog signal from the front-end circuit and convert the analog signal to a digital signal.

The radio receiver further includes a digital processing system operable to receive the digital signal from the analog to digital converter and generate at least one output signal corresponding to one or more of the digitized channels within the frequency band. Preferably, the digital processing system includes a digital down converter operable to simultaneously select the one or more channels within the frequency band according to software configurable channel selection parameters (e.g., channel frequency and channel bandwidth). The digital processing system also preferably includes a digital signal processor operable to extract information from the selected one or more channels according to software configurable channel decoding parameters (e.g., channel frequency, channel modulation scheme, channel bandwidth, and channel information format) and generate at least one output signal corresponding to that information.

In a second exemplary embodiment, the radio receiver includes a plurality of front-end circuits each of which is operable to receive a plurality of radio signals transmitted across a frequency band and generate an analog signal corresponding to a plurality of channels within the frequency band. The radio receiver also includes a single analog to digital converter operable to receive the analog signals from each of the front-end circuits and convert the combination of analog signals to a single digital signal. The radio receiver further includes a digital processing system operable to receive the digital signal from the analog to digital converter and generate at least one output signal corresponding to one or more of the digitized channels within the frequency band of at least one of the front end circuits.

In a third exemplary embodiment, the radio receiver includes a plurality of front-end circuit groups each of which includes a plurality of front-end circuits, wherein each of the front-end circuits is operable to receive a plurality of radio signals transmitted across a frequency band and generate an analog signal corresponding to a plurality of channels within the frequency band. The radio receiver also includes a plurality of analog to digital converters each of which is operable to receive the analog signals from one of the front-end circuit groups and convert the analog signals to a digital signal. The radio receiver further includes a digital processing system operable to receive the digital signals from the analog to digital converters and generate at least one output signal corresponding to one or more of the digitized channels within the frequency band of at least one of the front end circuits.

In a fourth exemplary embodiment, the radio receiver includes a plurality of front-end circuits each of which is operable to receive a plurality of radio signals transmitted across a frequency band and generate an analog signal corresponding to a plurality of channels within the frequency band. The radio receiver also includes a plurality of corresponding analog to digital converters each of which is operable to receive the analog signal from one of the front-end circuits and convert the analog signal to a digital signal. The radio receiver further includes a digital processing system operable to receive the digital signals from the analog to digital converters and generate at least one output signal corresponding to one or more of the digitized channels within the frequency band of at least one of the front end circuits.

The present invention will be better understood from the following detailed description of the invention, read in connection with the drawings as hereinafter described.

### BRIEF DESCRIPTION OF THE DRAWINGS

FIG. 1. is a block diagram of a first exemplary embodiment of the present invention in which a single front-end circuit is coupled to a single analog to digital converter, the output of which is processed by a digital processing system.

FIG. 2 is a block diagram of a second exemplary embodiment of the present invention in which a plurality of front-end circuits are coupled to a single analog to digital converter, the output of which is processed by a digital processing system.

FIG. 3 is a block diagram of a third exemplary embodiment of the present invention in which a plurality of front-end circuit groups (each including a plurality of front-end circuits) are coupled to a plurality of corresponding analog to digital converters, the outputs of which are processed by a digital processing system.

FIG. 4 is a block diagram of a fourth exemplary embodiment of the present invention in which a plurality of front-end circuits are coupled to a plurality of corresponding analog to digital converters, the outputs of which are processed by a digital processing system.

### DETAILED DESCRIPTION OF THE INVENTION

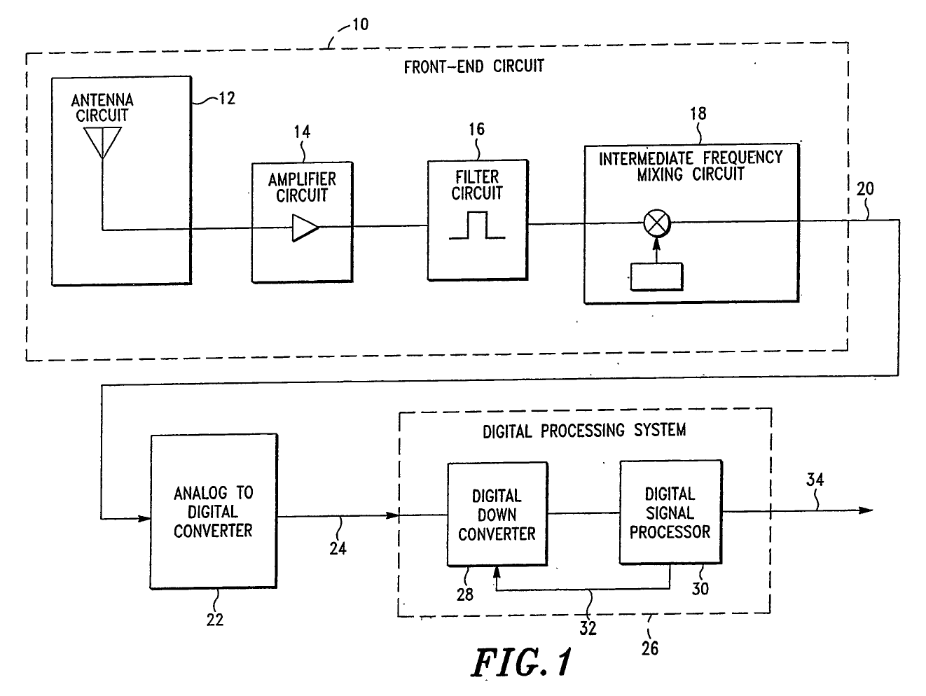

Radio receivers in accordance with various exemplary embodiments of the present invention are depicted in FIGS. 1-4. While the invention will be described in detail hereinbelow with reference to these exemplary embodiments, it should be understood that the invention is not limited to the specific architectures of the radio receivers shown in these embodiments. Rather, one skilled in the art will appreciate that a wide variety of radio receiver architectures may be implemented in accordance with the present invention.

In each of the exemplary embodiments, it will be seen that the invention is applied in particular to radio receivers used in the aviation industry. Preferably, these radio receivers are designed to comply with various aviation industry specifications. For example, aviation communications receivers are required to comply with the Radio Technical Commission for Aeronautics (RTCA) specifications DO-186a and DO-281, as well as the European Organization for Civil Aviation Electronics (EUROCAE) specifications ED-23B and ED-92. Similarly, aviation automatic direction finder (ADF) receivers are required to comply with RTCA specification DO-179 and EUROCAE specification ED-51. Other examples of specifications to be complied with are DO-196(VHF Omni-range), DO-195(localizer), and DO-192(glide slope). Thus, the specific architecture of these radio receivers may be adapted to comply with such specifications, as required.

### First Exemplary Embodiment

Referring to FIG. 1, a radio receiver in accordance with a first exemplary embodiment of the present invention includes a front-end circuit 10 (which generally comprises an antenna circuit 12, an amplifier circuit 14, a filter circuit 16 and an intermediate frequency mixing circuit 18), an analog to digital converter 22, and a digital processing system 26 (which generally comprises a digital down converter 28 and a digital signal processor 30). As will be described in greater detail hereinbelow, front-end circuit 10 receives a plurality of radio signals transmitted across a frequency band and generates an analog signal 20 corresponding to a plurality of channels within that frequency band. Analog to digital converter 22 converts analog signal 20 into a digital signal 24 to thereby digitize the received radio signals. Digital signal 24 is then processed by digital processing system 26, which generates an output signal 34 corresponding to at least one of the digitized channels within the frequency band.

Looking more closely to FIG. 1, antenna circuit 12 is operable to receive a plurality of radio signals transmitted across a frequency band. Antenna circuit 12 includes a receiving antenna for detecting the broadcast radio signals. The receiving antenna may be configured to detect a wide frequency range of radio signals, such as the entire low frequency (LF) band (spanning 30 kHz to 300 kHz), the entire high frequency (HF) band (spanning 3 MHz to 30 MHz), the entire very-high frequency (VHF) band (spanning 30 MHz to 300 MHz), the entire ultra-high frequency (UHF) band (spanning 300 MHz to 3000 MHz) and/or the entire L-band (spanning 500 MHz to 1500 MHz). Alternatively, the receiving antenna may be configured to detect only a specific range of radio signals, such as the aeronautical communications band (spanning 118 MHz to 137 MHz), the aircraft navigation band (spanning 108 MHz to 118 MHz), the aircraft automatic direction finding band (spanning 190 kHz to 2.3 MHz), the glide slope band (spanning 328.6 MHz to 335.4 MHz), and/or the aeronautical navigation band (spanning 960 MHz to 1215 MHz). As is typical of most antenna circuits, antenna circuit 12 may also include filter circuitry tuned to limit the frequency range of the received radio signals to a particular frequency range.

Amplifier circuit 14 is operable to increase the amplitude of the received radio signals so that they may be more easily detected and processed by subsequent circuitry within the radio receiver. As is typical of most amplifier circuits, amplifier circuit 14 may include filter circuitry tuned to limit the frequency range of the received radio signals to match the specific bandwidth of amplifier circuit 14.

Filter circuit 16 is operable to filter the received radio signals such that only the desired signals are passed on to subsequent circuitry within the radio receiver. Filter circuit 16 may include a filter (such as a band-pass filter, a low-pass filter, a high-pass filter, a notch filter, or any combinations of such filters) that is tuned to pass only specific channels within the frequency band. Of course, it should be understood that filter circuit 16 may be tuned to simply pass the received radio signals without performing any filtering. As will now be described, filtering the received radio signals may be desired for a variety of purposes.

For example, filtering the received radio signals may be required to narrow a wide frequency band. For example, antenna circuit 12 and amplifier circuit 14 may be configured and tuned to receive the entire VHF frequency band (spanning 30 MHz to 300 MHz). However, for a particular application, only the aeronautical communications band (spanning 118 MHz to 137 MHz) within the VHF frequency band may be of interest. In such a case, filter circuit 16 may include a band-pass filter that is tuned to pass only the channels within the 118 MHz to 137 MHz frequency range.

Similarly, filtering the received radio signals may be required to eliminate unwanted signals within a frequency band. For example, antenna circuit 12 and amplifier circuit 14 may be configured and tuned to receive the aircraft navigation band (spanning 108 MHz to 118 MHz). However, a particular application may only require the radio signals within the 110 MHz to 112 MHz frequency range. In such a case, filter circuit 16 may include a band-pass filter that is tuned to pass only the channels within the 110 MHz to 112 MHz frequency range.

In addition, filtering the received radio signals may be required to remove interfering or spurious signals within a frequency band. For example, antenna circuit 12 and amplifier circuit 14 may be configured and tuned to receive the aeronautical navigation band (spanning 960 MHz to 1215 MHz). However, there may be a known interfering signal at 996 MHz, which may be a harmonic of a signal within an adjacent band or an interfering transmission from a foreign or non-compliant transmitter. In such a case, filter circuit 16 may include a notch filter that is tuned to remove the 996 MHz signal, allowing all of the other channels within the aeronautical navigation band to pass.

Intermediate frequency mixing circuit 18 is operable to translate the received radio signals to an intermediate frequency band. Translation of the received radio signals may be required to shift the received radio signals away from another frequency band in order to avoid interference with radio signals transmitted within that other frequency band. Also, translation of the received radio signals may be required to shift the received radio signals to a frequency range that is more compatible with the functionality of analog to digital converter 22 (described hereinbelow). As an example, if analog to digital converter 22 exhibits aliasing at particular frequencies, it may be necessary to shift the received radio signals to a frequency range that avoids the aliasing points. As is typical of most mixing circuits, intermediate frequency mixing circuit 18 may also include filter circuitry tuned to limit the frequency range of the received radio signals to the desired intermediate frequency band range.

As illustrated in FIG. 1, front-end circuit 10 includes antenna circuit 12, amplifier circuit 14, filter circuit 16, and intermediate frequency mixing circuit 18. It should be understood, however, that one or more of these circuits may not be necessary for a particular application. For example, the receipt of aviation glide slope radio signals (broadcast in he 328.6 MHz to 335.4 MHz frequency range) or ADF radio signals (broadcast in the 190 kHz to 1800 kHz range) may require only antenna circuit 12, amplifier circuit 14, and filter circuit 16 (with no intermediate frequency mixing circuit 18). Also, depending on the performance of analog to digital converter 22 (described hereinbelow) and the requirements of the receiver, only antenna circuit 12 may be necessary. Thus, the circuits included within front-end circuit 10 may vary between different applications.

It should also be understood that the order of antenna circuit 12, amplifier circuit 14, filter circuit 16, and intermediate frequency mixing circuit 18 within front-end circuit 10 is not critical and may be modified as required for a particular application. For example, antenna circuit 12 may feed directly into filter circuit 16 in order to filter the received radio signals before they are amplified by amplifier circuit 14. Also, amplifier circuit 14 may feed directly into intermediate frequency mixing circuit 18 in order to translate the received radio signals before they are filtered by filter circuit 16. Thus, the order of the circuits within front-end circuit 10 may vary between different applications.

It should further be understood that it is not necessary to confine the functionality of antenna circuit 12, amplifier circuit 14, filter circuit 16, and intermediate frequency mixing circuit 18 to separate or distinct sub-circuits (as described hereinabove). Rather, the function of any one of these circuits may be performed by another of the circuits within front-end circuit 10. For example, the amplification function performed by amplifier circuit 12 may be encompassed within intermediate frequency mixing circuit 18. Thus, the functionality of one or more of the circuits within front-end circuit 10 may be combined for a particular application.

Regardless of the architecture of front-end circuit 10, the various circuits included within front-end circuit 10 function together to generate analog signal 20. For some applications, analog signal 20 may correspond to all of the radio signals transmitted across the frequency band. For other applications, analog signal 20 may correspond to the radio signals transmitted across a predetermined range within the frequency band (e.g., due to filtering of the received radio signals). In either case, analog signal 20 includes all of the information carried by the channels of the desired frequency range.

Looking still to FIG. 1, analog to digital converter 22 is operable to receive analog signal 20 from front-end circuit 10 and convert analog signal 20 to digital signal 24 for processing by digital processing system 26 (described hereinbelow). It should be understood that any analog to digital converter that meets the conversion requirements for a particular application may be used. For example, in an aviation receiver application, the sampling rate and spurious-free dynamic range of the analog to digital converter is preferably selected to ensure that the converted signals comply with aviation industry specifications. The analog to digital converter part number AD6645 sold by Analog Devices (a 14 bit converter that samples at a rate of more than 100 million samples per second) may be used to comply with such specifications, depending on the requirements of the plurality of channels within analog signal 20.

Looking again to FIG. 1, digital down converter 28 is operable to select one or more desired channels within the frequency band from digital signal 24. Preferably, digital down converter 28 utilizes configurable channel selection parameters (such as channel frequency, channel bandwidth, and combinations thereof) to permit selection of the desired channels. Preferably, the channel selection parameters are software configurable to facilitate such selection. As an example, digital signal 24 may include all of the channels within the VHF aviation communications band (spanning 118 MHz to 137 MHz). If a particular application requires information carried only on a channel at 119 MHz, then a user may indicate to digital down converter 28 that information is needed only on this channel and digital down converter 28 will select and process the channel at 119 MHz and pass the baseband (i.e. 0 Hz) information to digital signal processor 30. If another particular application requires information carried on channels at 121.5 MHz, 118.9 MHz and 136.5 MHz, then the user may indicate to digital down converter 28 that information is needed on all of these channels and digital down converter 28 will simultaneously select and process all three channels and pass the baseband information of each of the channels to digital signal processor 30. It should be understood that the number of channels simultaneously processed to a digitized baseband signal by digital down converter 28 is limited only by the hardware used to implement the down conversion process.

It should be understood that any digital down converter that meets the channel selection requirements for a particular application may be used. For example, in an aviation receiver application, the digital down converter is preferably selected to ensure compliance with aviation industry specifications. The digital down converter part number AD6624 sold by Analog Devices may be used to comply with such specifications.

Digital signal processor 30 is operable to extract information from the digitized baseband channel(s) selected by digital down converter 28. Control signals 32 from digital signal processor 30 allow it to communicate with and control digital down converter 28. Preferably, digital signal processor 30 utilizes configurable channel decoding parameters (such as channel frequency, channel modulation scheme, channel bandwidth, channel information format, and combinations thereof) to define the decoding scheme for the selected channel(s). Preferably, the channel decoding parameters are software configurable so that the definition of the decoding scheme may be changed for different applications. It should be understood that any digital signal processor that meets the decoding requirements for a particular application may be used. For example, in an aviation radio receiver application, the digital signal processor part number TMS320C6713 sold by Texas Instruments may be used to comply with aviation industry specifications.

Once information has been extracted from the selected channel(s), digital signal processor 30 generates an output signal 34 that corresponds to the extracted information. In the illustrated embodiment, output signal 34 is a high-speed serial data link and digital signal processor 30 allocates time slots within the serial data link according to the amount of information carried within each selected channel. For example, information from an 8 kHz aviation audio channel may receive only one time slot within output signal 34, while an aviation data link channel may receive three time slots within output signal 34. This type of output signal is often referred to as a time-domain multiplexed (TDM) serial data link.

Finally, output signal 34 may then be transmitted to a controller (not shown) that processes output signal 34 and generates a plurality of analog and/or digital signals (as required for a particular application) for transmission to a plurality of end devices or instruments (not shown). For example, in an aviation receiver application, audio detected from communication signals may be routed to the aircraft audio panel. Also, navigation signals (such as glide slope, localizer, VHF omni-range, and automatic direction finding signals) may be routed in either analog and/or digital formats to mechanical indicators and/or electronic displays (such as EFIS or multi-function displays). In addition, VDL weather data may be routed digitally to a multi-function display for viewing in map format. Of course, it should be understood that the functionality of the controller could be performed within digital processing system 26 such that digital processing system 26 generates a plurality of output signals (i.e. a plurality of analog and/or digital signals for transmission to a plurality of end devices or instruments).

### Second Exemplary Embodiment

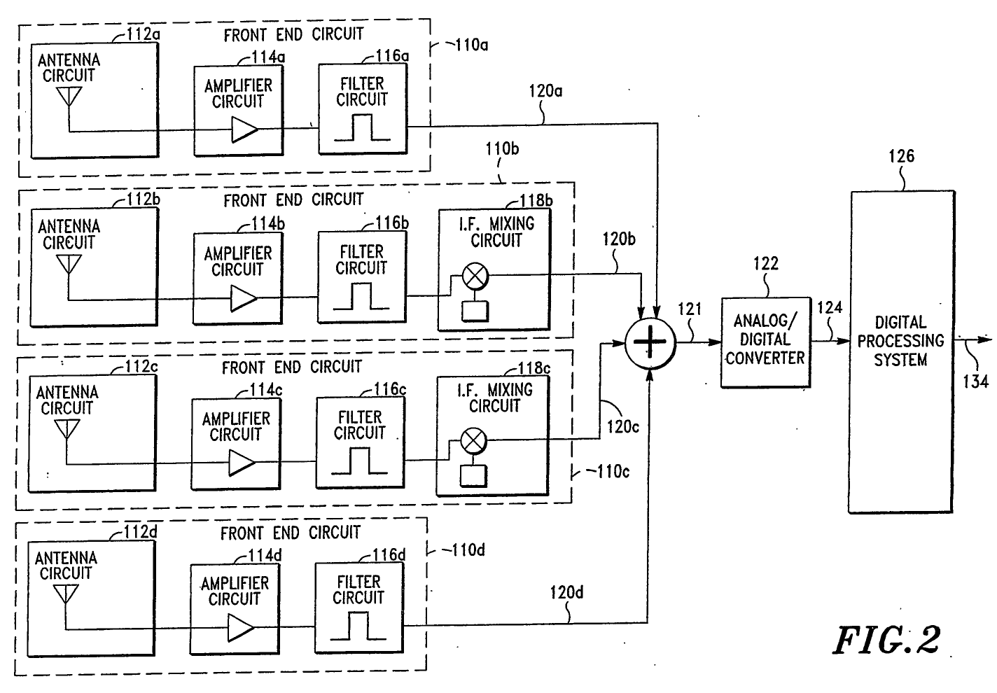

Turning now to FIG. 2, a radio receiver in accordance with a second exemplary embodiment of the present invention includes a plurality of front-end circuits 110a, 110b, 110c, 110d (each of which is configured in accordance with the description of front-end circuit 10 of the first exemplary embodiment), an analog to digital converter 122 (which is configured in accordance with the description of analog to digital converter 22 of the first exemplary embodiment), and a digital processing system 126 (which is configured in accordance with the description of digital processing system 26 of the first exemplary embodiment).

As can be seen, front-end circuit 110a includes an antenna circuit 112a, an amplifier circuit 114a and a filter circuit 116a (but no intermediate frequency circuit); front-end circuit 112b includes an antenna circuit 112b, an amplifier circuit 114b, a filter circuit 116b and an intermediate frequency mixing circuit 118b; front-end circuit 112c includes an antenna circuit 112c, an amplifier circuit 114c, a filter circuit 116c and an intermediate frequency mixing circuit 118c; and front-end circuit 110d includes an antenna circuit 112d, an amplifier circuit 114d and a filter circuit 116d (but no intermediate frequency mixing circuit).

Each of front-end circuits 110a, 110b, 110c, 110d is operable to receive a plurality of radio signals transmitted across a particular frequency band and generate an analog output signal 120a, 120b, 120c, 120d corresponding to a plurality of channels within that frequency band. Although four front-end circuits have been illustrated in FIG. 2, it should be understood that the radio receiver may include any number of front-end circuits.

Typically, the radio signals received by each of front-end circuits 110a, 110b, 110c, 110d are within a different frequency band than the radio signals received by the other front-end circuits. For example, in an aviation receiver application, front-end circuit 110a may be configured to receive glide slope radio signals (broadcast in the 328.6 MHz to 335.4 MHz frequency range), front-end circuit 110b may be configured to receive the aircraft navigation band (spanning 108 MHz to 118 MHz), front-end circuit 110c may be configured to receive the aeronautical communications band (spanning 118 MHz to 137 MHz), and front-end circuit 110d may be configured to receive ADF radio signals (broadcast in the 190 kHz to 1800 kHz frequency range). Thus, each of the front-end circuits is associated with a particular frequency band.

As can be seen in FIG. 2, analog output signals 120a, 120b, 120c, 120d from each of front-end circuits 110a, 110b, 110c, 11od are combined into a single analog signal 121 that feeds into analog to digital converter 122. Analog signal 121 is thus a composite analog signal corresponding to all of the channels within analog output signals 120a, 120b, 120c, 120d.

Analog to digital converter 122 is operable to convert analog signal 121 to digital signal 124 for processing by digital processing system 126. Digital processing system 126 is operable to select one or more desired channels from digital signal 124, extract information from the selected channel(s), and generates an output signal 134 (e.g., a time-domain multiplexed serial data link) that corresponds to the extracted information. Thus, digital processing system 126 may be used to simultaneously demodulate and decode information from a variety of different channels, even if those channels are within different frequency ranges and use different modulation and encoding schemes.

Digital processing system 126 may then transmit output signal 134 to a controller (not shown) that processes output signal 134 and generates a plurality of analog and/or digital signals (as required for a particular application) for transmission to a plurality of end devices or instruments (not shown). Alternatively, the functionality of the controller could be performed within digital processing system 126.

### Third Exemplary Embodiment

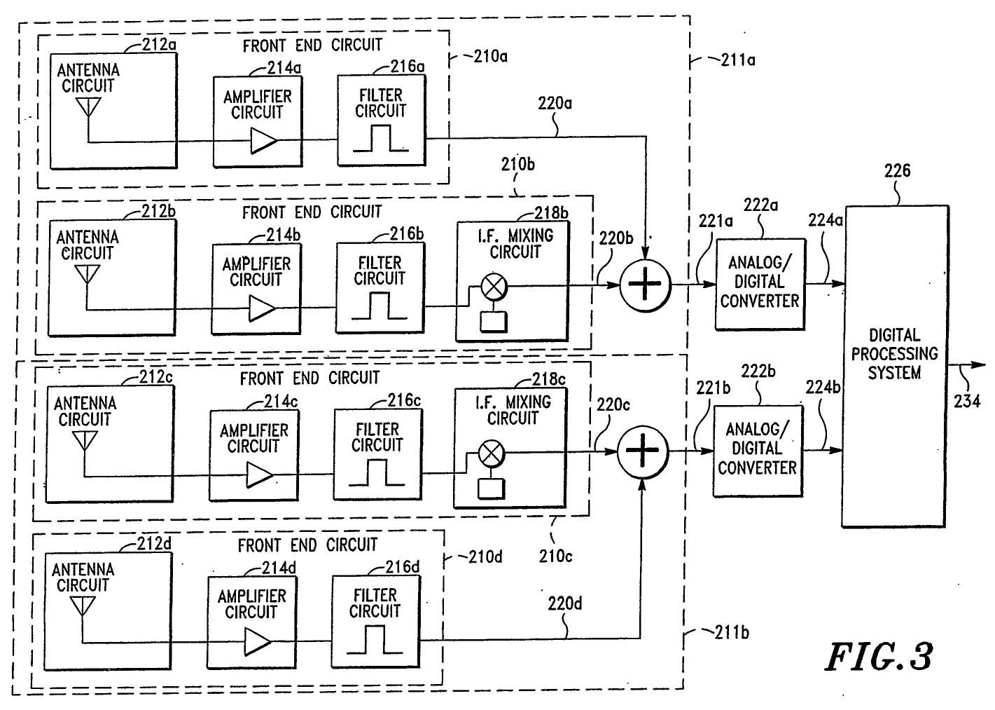

Turning next to FIG. 3, a radio receiver in a accordance with a third exemplary embodiment of the present invention includes two front-end circuit groups 211a, 211b. Front-end circuit group 211a includes a plurality of front-end circuits 210a, 210b and front-end circuit group 211b includes a plurality of front-end circuits 210c, 210d (wherein each of the front-end circuits is configured in accordance with the description of front-end circuit 10 of the first exemplary embodiment). The radio receiver also includes a plurality of analog to digital converters 222a, 222b (each of which is configured in accordance with the description of analog to digital converter 22 of the first exemplary embodiment), and a digital processing system 226 (which is configured in accordance with the description of digital processing system 26 of the first exemplary embodiment).

Within front-end circuit group 211a, front-end circuit 210a includes an antenna circuit 212a, an amplifier circuit 214a and a filter circuit 216a (but no intermediate frequency circuit), and front-end circuit 212b includes an antenna circuit 212b, an amplifier circuit 214b, a filter circuit 216b and an intermediate frequency mixing circuit 218b. Within front-end circuit group 211b, front-end circuit 212c includes an antenna circuit 212c, an amplifier circuit 214c, a filter circuit 216c and an intermediate frequency mixing circuit 218c, and front-end circuit 210d includes an antenna circuit 212d, an amplifier circuit 214d and a filter circuit 216d (but no intermediate frequency mixing circuit).

Each of front-end circuits 210a, 210b, 210c,

210d is operable to receive a plurality of radio signals transmitted across a particular frequency band and generate an analog output signal 220a, 220b, 220c, 220d corresponding to a plurality of channels within that frequency band. Typically, the radio signals received by each of front-end circuits 210a, 210b, 210c, 210d are within a different frequency band than the radio signals received by the other front-end circuits. Although two front-end circuit groups (each of which includes two front-end circuits) have been illustrated in FIG. 3, it should be understood that the radio receiver may include any number of front-end circuit groups that include any number of front-end circuits.

As can be seen in FIG. 3, analog output signals 220a, 220b from front-end circuits 210a, 210b are combined into a single analog signal 221a that feeds into analog to digital converter 222a. Analog signal 221a is thus a composite analog signal corresponding to all of the channels within analog signals 220a, 220b. Similarly, analog output signals 220c, 220d from front-end circuits 210c, 210d are combined into a single analog signal 221b that feeds into analog to digital converter 222b. Analog signal 221b is thus a composite analog signal corresponding to all of the channels within analog signals 220c, 220d.

Analog to digital converter 222a is operable to convert analog signal 221a to digital signal 224a for processing by digital processing system 226. Similarly, analog to digital converter 222b is operable to convert analog signal 221b to digital signal 224b for processing by digital processing system 226. Digital processing system 226 is operable to select one or more desired channels from digital signals 224a, 224b, extract information from the selected channel(s), and generate an output signal 234 (e.g., a time-domain multiplexed serial data link) that corresponds to the extracted information. Thus, digital processing system 226 may be used to simultaneously demodulate and decode information from a variety of different channels, even if those channels are within different frequency ranges and use different modulation and encoding schemes.

Digital processing system 226 may then transmit output signal 234 to a controller (not shown) that processes output signal 234 and generates a plurality of analog and/or digital signals (as required for a particular application) for transmission to a plurality of end devices or instruments (not shown). Alternatively, the functionality of the controller could be performed within digital processing system 226.

### Fourth Exemplary Embodiment

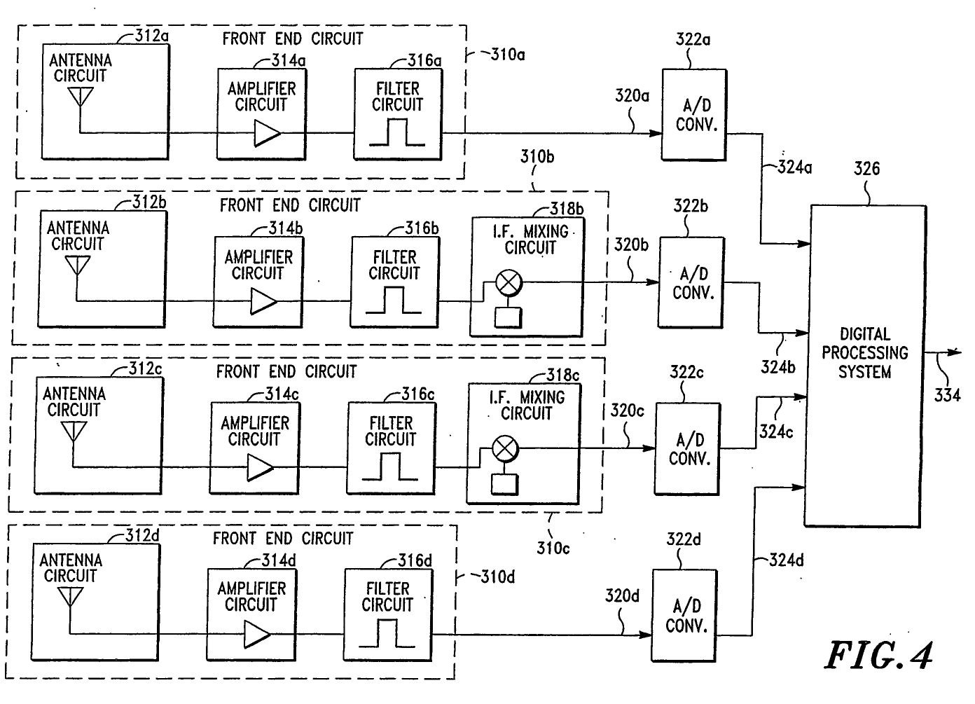

Turning now to FIG. 4, a radio receiver in a accordance with a fourth exemplary embodiment of the present invention includes a plurality of front-end circuits 310a, 310b, 310c, 310d (each of which is configured in accordance with the description of front-end circuit 10 of the first exemplary embodiment), a plurality of analog to digital converters 322a, 322b, 322c, 322d (each of which is configured in accordance with the description of analog to digital converter 22 of the first exemplary embodiment), and a digital processing system 326 (which is configured in accordance with the description of digital processing system 26 of the first exemplary embodiment).

Each of front-end circuits 310a, 310b, 310c, 310d is operable to receive a plurality of radio signals transmitted across a particular frequency band and generate an analog output signal 320a, 320b, 320c, 320d corresponding to a plurality of channels within that frequency band. Typically, the radio signals received by each of front-end circuits 310a, 310b, 310c, 310d are within a different frequency band than the radio signals received by the other front-end circuits. Although four front-end circuits have been illustrated in FIG. 4, it should be understood that the radio receiver may include any number of front-end circuits.

As can be seen in FIG. 4, analog output signal 320a from front-end circuit 310a feeds into analog to digital converter 322a, analog output signal 320b from front-end circuit 310b feeds into analog to digital converter 322b, analog output signal 320c from front-end circuit 310c feeds into analog to digital converter 322c, and analog output signal 320d from front-end circuit 310d feeds into analog to digital converter 322d. Thus, each of the front-end circuits is associated with its own analog to digital converter.

Each of analog to digital converters 322a, 322b, 322c, 322d is operable to convert its associated analog signal 320a, 320b, 320c, 320d to digital signal 324a, 324b, 324c, 324d for processing by digital processing system 326. Digital processing system 326 is operable to select one or more desired channels from digital signals 324a, 324b, 324c, 324d, extract information from the selected channel(s), and generate an output signal 334 (e.g., a time-domain multiplexed serial data link) that corresponds to the extracted information. Thus, digital processing system 326 may be used to simultaneously demodulate and decode information from a variety of different channels, even if those channels are within different frequency ranges and use different modulation and encoding schemes.

Digital processing system 326 may then transmit output signal 334 to a controller (not shown) that processes output signal 334 and generates a plurality of analog and/or digital signals (as required for a particular application) for transmission to a plurality of end devices or instruments (not shown). Alternatively, the functionality of the controller could be performed within digital processing system 326.

While the present invention has been described and illustrated hereinabove with reference to several exemplary embodiments, it should be understood that various modifications could be made to these embodiments without departing from the scope of the invention. Therefore, the invention is not to be limited to the specific embodiments described and illustrated hereinabove, except insofar as such limitations are included in the following claims.

What is claimed:

1. A radio receiver, comprising:
a front-end circuit operable to receive a plurality of radio signals transmitted across a frequency band and generate an analog signal corresponding to a plurality of channels within said frequency band;
an analog to digital converter coupled to said front-end circuit, said analog to digital converter operable to receive and convert said analog signal to a digital signal; and
a digital processing system coupled to said analog to digital converter, said digital processing system operable to receive said digital signal and generate at least one output signal corresponding to at least one of said plurality of channels within said frequency band.

2. The radio receiver of claim 1, wherein said digital processing system generates a single output signal comprising a time-domain multiplexed serial data link.

3. The radio receiver of claim 2, further comprising a controller coupled to said digital processing system, said controller operable to receive said time-domain multiplexed serial data link and generate a plurality of signals for transmission to a plurality of end devices.

4. The radio receiver of claim 1, wherein said digital processing system generates a plurality of output signals comprising a plurality of signals for transmission to a plurality of end devices.

5. The radio receiver of claim 1, wherein said front-end circuit comprises an antenna circuit operable to receive said radio signals.

6. The radio receiver of claim 5, wherein said front-end receiver further comprises an amplifier circuit operable to amplify said received radio signals.

7. The radio receiver of claim 5, wherein said front-end circuit further comprises a filter circuit operable to filter said received radio signals.

8. The radio receiver of claim 7, wherein said filter circuit comprises a filter selected from the following group: high-pass filter, low-pass filter, band-pass filter, notch filter, and combinations thereof.

9. The radio receiver of claim 5, wherein said front-end circuit further comprises an intermediate frequency mixing circuit operable to translate said received radio signals to an intermediate frequency band.

10. The radio receiver of claim 1, wherein said digital processing system comprises:
a digital down converter operable to select said at least one of said channels within said frequency band; and
a digital signal processor operable to extract information from said at least one of said channels and generate said at least one output signal.

11. The radio receiver of claim 10, wherein said digital down converter selects said at least one of said channels according to configurable channel selection parameters.

12. The radio receiver of claim 11, wherein said configurable channel selection parameters are software configurable.

13. The radio receiver of claim 11, wherein said configurable channel selection parameters are selected from the following group: channel frequency, channel bandwidth, and combinations thereof.

14. The radio receiver of claim 10, wherein said digital signal processor extracts said information from said at least one of said selected channels according to configurable channel decoding parameters.

15. The radio receiver of claim 14, wherein said configurable channel decoding parameters are software configurable.

16. The radio receiver of claim 14, wherein said configurable channel decoding parameters are selected from the following group: channel frequency, channel modulation scheme, channel bandwidth, channel information format, and combinations thereof.

17. The radio receiver of claim 10, wherein said digital signal processor controls said digital down converter.

18. A radio receiver comprising:
at least one front-end circuit group comprising a plurality of front-end circuits, wherein each of said front-end circuits is operable to receive a plurality of radio signals transmitted across a frequency band and generate an analog signal corresponding to a plurality of channels within said frequency band;
at least one analog to digital converter coupled to said at least one front-end circuit group, said analog to digital converter operable to receive said analog signals from said front-end circuits and convert said analog signals to a digital signal; and
a digital processing system coupled to said at least one analog to digital converter, said digital processing system operable to receive said digital signal from said analog to digital converter and generate at least one output signal corresponding to at least one of said channels within said frequency band of at least one of said front-end circuits.

19. The radio receiver of claim 18, wherein said digital processing system is operable to generate a plurality of output signals, wherein each of said output signals corresponds to at least one of said channels within said frequency band of at least one of said front-end circuits.

20. The radio receiver of claim 18, wherein said radio signals received by any one of said front-end circuits are within a different frequency band than said radio signals received by the other of said front-end circuits.

21. The radio receiver of claim 18, wherein each of said front-end circuits comprises an antenna circuit operable to receive said radio signals.

22. The radio receiver of claim 21, wherein at least one of said front-end circuits further comprises an amplifier circuit operable to amplify said received radio signals.

23. The radio receiver of claim 21, wherein at least one of said front-end circuits further comprises a filter circuit operable to filter said received radio signals.

24. The radio receiver of claim 21, wherein at least one of said front-end circuits further comprises an intermediate frequency mixing circuit operable to translate said received radio signals to an intermediate frequency band.

25. The radio receiver of claim 18, wherein said digital processing system comprises:
a digital down converter operable to select said at least one of said channels within said frequency band of at least one of said front-end circuits; and
a digital signal processor operable to extract information from said at least one of said selected channels and generate said at least one output signal.

26. The radio receiver of claim 25, wherein said digital down converter selects said at least one of said channels according to software configurable channel selection parameters.

27. The radio receiver of claim 25, wherein said digital signal processor extracts said information from said at least one of said selected channels according to software configurable channel decoding parameters.

28. The radio receiver of claim 18, comprising a plurality of front-end circuit groups and a plurality of corresponding analog to digital converters, wherein said digital processing system is operable to receive a plurality of digital signals from said analog to digital converters and generate at least one output signal corresponding to at least one of said channels within said frequency band of at least one of said front-end circuits of at least one of said front-end circuit groups.

29. A radio receiver, comprising:
a plurality of front-end circuits each of which comprises an antenna circuit operable to receive a plurality of radio signals transmitted across a frequency band, wherein each of said front end circuits is operable to generate an analog signal corresponding to a plurality of channels within said frequency band;
a plurality of analog to digital converters each of which is coupled to at least one of said front-end circuits, wherein each of said analog to digital converters is operable to receive said analog signal from said at least one of said front-end circuits and convert said analog signal to a digital signal; and
a digital processing system coupled to each of said analog to digital converters, said digital processing system operable to receive said digital signals from said analog to digital converters and generate at least one output signal corresponding to at least one of said channels within said frequency band of at least one of said front-end circuits.

30. The radio receiver of claim 29, wherein at least one of said front-end circuits further comprises an amplifier circuit operable to amplify said received radio signals.

31. The radio receiver of claim 29, wherein at least one of said front-end circuits further comprises a filter circuit operable to filter said received radio signals.

32. The radio receiver of claim 29, wherein at least one of said front-end circuits further comprises an intermediate frequency mixing circuit operable to translate said received radio signals to an intermediate frequency band.

33. The radio receiver of claim 29, wherein at least one of said analog to digital converters is operable to receive analog signals from a plurality of front-end circuits and convert said analog signals to a digital signal.

34. A method of receiving radio signals, comprising:
receiving a plurality of radio signals transmitted across a frequency band;
generating an analog signal from said received radio signals, said analog signal comprising a plurality of channels within said frequency band;
converting said analog signal to a digital signal to thereby digitize said plurality of channels within said frequency band; and
generating at least one output signal corresponding to at least one of said digitized channels within said frequency band.

35. The method of claim 34, further comprising amplifying said received radio signals.

36. The method of claim 34, further comprising filtering said received radio signals.

37. The method of claim 34, further comprising mixing said received radio signals to an intermediate frequency band.

38. The method of claim 34, wherein said output signal is generated by:
applying software configurable channel selection parameters to said digital signal to select at least one of said digitized channels within said frequency band;
extracting information from said at least one of said selected digitized channels according to software configurable channel decoding parameters; and
conveying said extracted information within said output signal.

38. The method of claim 38, wherein said output signal comprises a time-domain multiplexed serial data link.

40. The method of claim 39, further comprising generating a plurality of signals from said time-domain multiplexed serial data link for transmission to a plurality of end devices.

41. The method of claim 34, wherein a plurality of output signals are generated each of which corresponds to at least one of said digitized channels within said frequency band.

42. The method of claim 41, wherein said plurality of output signals comprise a plurality of signals for transmission to a plurality of end devices.

43. A radio receiver, comprising:
means for receiving a plurality of radio signals transmitted across a frequency band and generating an analog signal corresponding to a plurality of channels within said frequency band;
means for converting said analog signal to a digital signal; and
means for generating at least one output signal from said digital signal, said output signal corresponding to at least one of said channels within said frequency band.

44. The radio receiver of claim 43, wherein said output signal comprises a time-domain multiplexed serial data link.

45. The radio receiver of claim 44, further comprising means for generating a plurality of signals from said time-domain multiplexed serial data link for transmission to a plurality of end devices.
